(19) United States
(12) Patent Application Publication
(10) Pub. No.: US 2017/0303743 A1
(43) Pub. Date: Oct. 26, 2017

(54) COOKING APPARATUS WITH STRAINER

(71) Applicant: CHAUDWAY ENTERPRISES LLC, Powell, OH (US)

(72) Inventors: Adam Chaudry, Powell, OH (US); Josh Conway, Powell, OH (US); Joseph Lehman, New Albany, OH (US); Sean D Montag, Westerville, OH (US)

(21) Appl. No.: 15/645,403

(22) Filed: Jul. 10, 2017

Related U.S. Application Data
(63) Continuation-in-part of application No. 14/949,192, filed on Nov. 23, 2015.
(60) Provisional application No. 62/360,929, filed on Jul. 11, 2016.

(51) Int. Cl. A47J 37/10

(52) U.S. Cl. CPC A47J 37/108

(57) ABSTRACT

A cooking apparatus having a pivoting strainer which provides a unique, safe way to drain liquid contents contained within the apparatus while cooking. The cooking apparatus generally comprises a substantially flat and circular base having a cooking surface, a peripheral wall upstanding from the circular base, a handle extending outwardly from the peripheral wall and a pivoting strainer moveable between a closed position and a raised, draining position.

This application is based upon and claims the priority filing date of the previously filed, copending U.S. Provisional patent application entitled “U.S. Utility patent application entitled “Cooking Apparatus with Grease Strainer” filed Jul. 11, 2016, Ser. No. 62/360,929, the entire disclosure of which is hereby incorporated herein by reference; and, as a continuation-in-part of, copending U.S. Non-Provisional patent application entitled “Cooking Apparatus with Grease Strainer” filed Nov. 23, 2015, Ser. No. 14/949,192, the entire disclosure of which is hereby incorporated herein by reference.

### BACKGROUND

The present invention relates to a cooking apparatus and, in particular, to an improved cooking apparatus having a strainer for removing liquid food components away from solid food contained therein.

Cooking apparatuses including pots and pans are well known in the culinary utensil art. Cooking pots and pans are generally a flat-bottomed container having an open top used for boiling water and food preparation. Typical cooking pots vary in size and diameter having relatively high sides that vertically extend upwards, a long handle, and no lid. Larger pots may have a small grab handle opposite the main handle. Traditionally, cooking pots were made of cast iron. Although cast iron is still popular today, especially for outdoor cooking, most cooking pots are now made from metals such as aluminum or stainless steel.

Cooking pots typically are relatively satisfactory for their intended purposes. However, on the other hand, the conventional cooking pot lacks special features that may increase the efficiency and ease of use of preparing food in a pot.

When it comes to attempting to drain a pot or pan from grease or other liquid components while keeping the solid food within, it can be quite the challenge for even a seasoned professional chef. Grease, water and other liquids are generally very hot and must be handled with extreme care. Not only is it difficult to ascertain the proper angle at which the pot must be tilted in order to commence the liquid drainage, but the angle must be slowly increased to maintain liquid flow. Accordingly, both chefs and amateur cooks tend to use a supporting culinary utensil, such as a pot cover or a large spoon or fork, to assist in draining the excess liquid by attempting to retain the solid food within the pot while allowing the liquid to drain over out of the pot. This process can prove to be awkward and if not done properly, hot liquids can spill or splash onto the handler, causing severe burns.

For the foregoing reason, there is a need for a cooking pot that will provide an efficient cooking surface as well as provide a safe and reliable manner of disposing of hot liquids contained therein.

### SUMMARY

In accordance with the invention, a cooking apparatus is provided which boasts the ability to provide a continuous cooking surface as well as provide a unique “flip up” or pivoting strainer moveable between a lowered, closed position to a raised, draining position for preventing burns and other injuries relating to draining a cooking pot or pan of its liquid contents. This provides a safe, ergonomic, and efficient cooking apparatus.

The cooking apparatus for straining grease and other liquid components away from solid food, generally comprises: (a) a substantially flat and circular base having a cooking surface; (b) a peripheral wall upstanding from the base terminating with an upper curved rim; (c) a handle extending outwardly from the peripheral wall; (d) a curved rim extension surface extending laterally away from a limited segment of the upper curved rim and terminating at an outer perimeter; (e) a pivoting strainer moveable relative to the peripheral wall and curved rim extension surface, the pivoting strainer comprising a curved surface generally concentric to that of the curved extension surface outer perimeter and a plurality of drainage perforations; and (f) a means for moving the pivoting strainer relative to the upper curved rim between i) a draining position, wherein the pivoting strainer extends above a limited segment of the peripheral wall and curved rim extension surface exposing the perforations to the interior contents of the cooking apparatus; and ii) a closed position wherein the pivoting strainer is positioned such that it does not interfere with the conventional configuration of the cooking apparatus and cooking surfaces.

In a detailed version of the invention, the pivoting strainer further comprises a lower terminating perimeter which is concentric to the curved rim extension surface of the cooking apparatus, wherein while in the draining position the lower terminating perimeter couples with the curved rim extension surface by an interference type fit, thereby preventing the pivoting strainer from moving upward and providing a seal between the apparatus and the pivoting strainer during the straining process.

In yet another version, the pivoting strainer further comprises an upper perimeter which is concentric to the curved rim extension surface outer perimeter, wherein while in the closed position the upper perimeter couples with the curved rim extension surface by an interference type fit.

Moreover, in a detailed version of the invention, the means for moving the pivoting strainer comprises a lever which can be actuated by the user's thumb while holding the apparatus by the handle, the lever is operably attached to the pivoting strainer which is rotatable about a pivot axis and extends above the apparatus handle near the position of the user's thumb, thereby as the lever is depressed by the user's thumb while holding the handle, the pivoting strainer pivots about the pivot axis moving from the closed position to the raised, draining position.

In a version of the pivoting strainer, the drainage perforations are configured and dimensioned to substantially block the passage of solid food therethrough. In a particularly detailed version, the drainage perforations are a plurality of aligned elongated slits extending upward within the curvature of the pivoting strainer.

These and other features of the present invention will become readily apparent upon further review of the following specification and drawings.

### DESCRIPTION OF THE DRAWINGS

These and other features, aspects, and advantages of the present invention will become better understood with regard to the following description and accompanying figures where:

FIG. 1 is a front, side perspective view of a first version of the application showing the pivoting strainer while in a closed position;

FIG. 2 is an exploded view of the version shown in FIG. 1;

FIG. 3 is a rear, side perspective view of the of the version shown in FIG. 1;

FIG. 4 is front elevation view of the version shown in FIG. 1;

FIG. 5 is a left side elevation view of the version shown in FIG. 1;

FIG. 6 is a top plan view of the version shown in FIG. 1;

FIG. 7 is a right side elevation view of the version shown in FIG. 1;

FIG. 8 is a rear elevation view of the version shown in FIG. 1;

FIG. 9 is a top plan view of the version shown in FIG. 1;

FIG. 10 is a cross sectional view of FIG. 9 taken along lines A-A showing the pivoting strainer in the closed position;

FIG. 11 is an enlarged view taken from FIG. 10 of the pivoting strainer shown in the closed position;

FIG. 12 is a front, side perspective view of the version shown in FIG. 1 showing the pivoting strainer while in the draining position;

FIG. 13 is a rear, side perspective view of the version shown in FIG. 12;

FIG. 14 is a front elevation view of the version shown in FIG. 12;

FIG. 15 is a left side elevation view of the version shown in FIG. 12;

FIG. 16 is a top plan view of the version shown in FIG. 12;

FIG. 17 is a right side elevation view of the version shown in FIG. 12;

FIG. 18 is a rear elevation view of the version shown in FIG. 12;

FIG. 19 is a top plan view of the version shown in FIG. 12;

FIG. 20 is a cross sectional view of FIG. 19 taken along lines A-A showing the pivoting strainer in the draining position;

FIG. 21 is an enlarged view taken from FIG. 20 of the pivoting strainer shown in the draining position;

FIG. 22 is a front elevation view of a version of the pivoting strainer shown without the cooking container;

FIG. 23 is a left side elevation view of the version shown in FIG. 22;

FIG. 24 is a top plan view of the version shown in FIG. 22;

FIG. 25 is a right side elevation view of the version shown in FIG. 22;

FIG. 26 is a rear elevation view of the version shown in FIG. 22;

FIG. 27 is a top side perspective view of the version shown in FIG. 22;

FIG. 28 is a rear side perspective view of the version shown in FIG. 22;

FIG. 29 is a top plan view of the version shown in FIG. 22;

FIG. 30 is a cross sectional view of the pivoting strainer shown in FIG. 29 taken along lines A-A; and

FIG. 31 is an enlarged view taken from FIG. 30 of the pivoting strainer.

### DETAILED DESCRIPTION

Referring now to the figures wherein the showings are for purposes of illustrating a preferred version of the invention only and not for purposes of limiting the same, the present invention is a cooking apparatus having a pivoting strainer which provides a unique, safe way to drain grease and other fluid food components therein while cooking.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims.

Various inventive features are described below that can each be used independently of one another or in combination with other features.

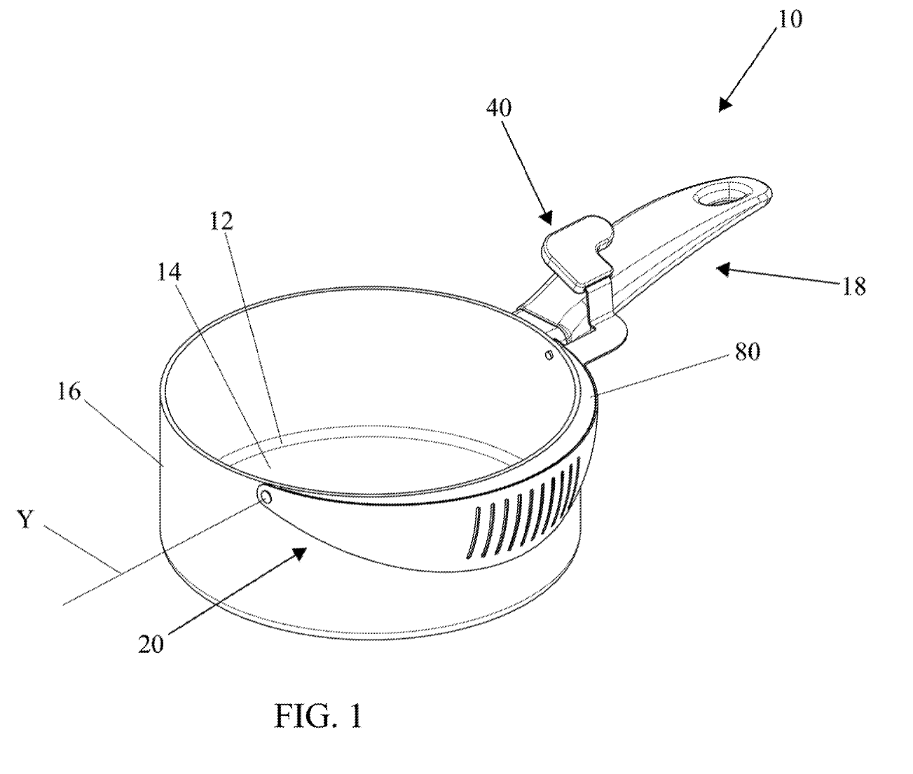

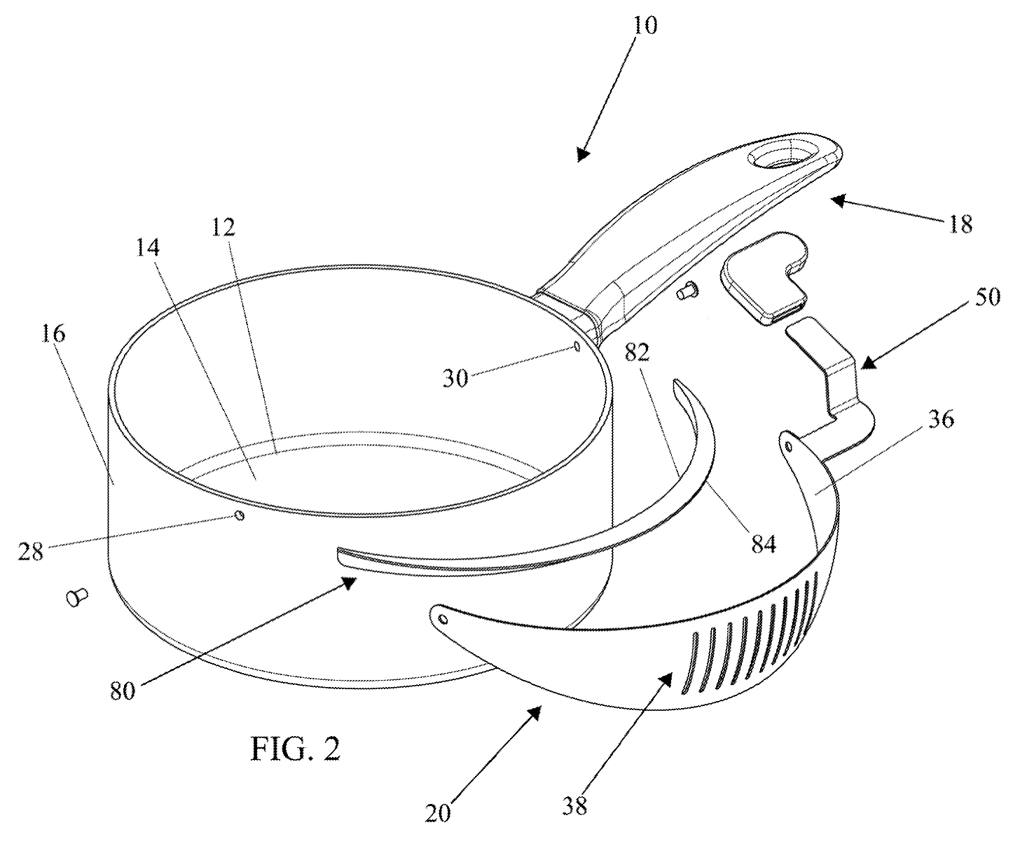

With reference to the figures, particularly FIG. 1 and FIG. 2 thereof, therein illustrated is a cooking apparatus or pot having a pivoting strainer according to a first embodiment of the present invention, generally designated by numeral 10. FIG. 1 is an illustrative front perspective view showing the version 10 in a closed configuration. The cooking apparatus or pot 10 generally comprises a substantially flat and circular base 12 having a cooking surface 14, a peripheral wall 16 having at least a segment of a vertical cross-section upstanding from said circular base 12, a curved rim extension surface 80, a handle 18 extending outwardly from the peripheral wall 16 and a pivoting strainer assembly 20 moveable between a closed position and a raised, draining position.

The circular base 12 and cooking surface 14 are conventional in nature. Ideally, the cooking surface 14 is generally flat and configured to cook and transfer heat to food as customary known in the culinary art. It will be noted, that the base 12 may be other than totally flat and other than exactly circular, just as the peripheral wall 16 may extend either vertically (perpendicular to the base) or slightly outward as well—either linearly or arcuately or even a combination thereof. The circular base 12 and peripheral wall 16 are imperforate and cooperate to define an open-top container for holding the food to be cooked, including any liquid associated therewith. The invention is not limited to merely pots having high vertical sides, but may include other cooking apparatuses such as any container having a cooking surface, peripheral sides, and an open top such as a pan or skillet. Thus, the invention should not be limited simply in the context of a pot formed by higher peripheral walls, but other cooking containers as well.

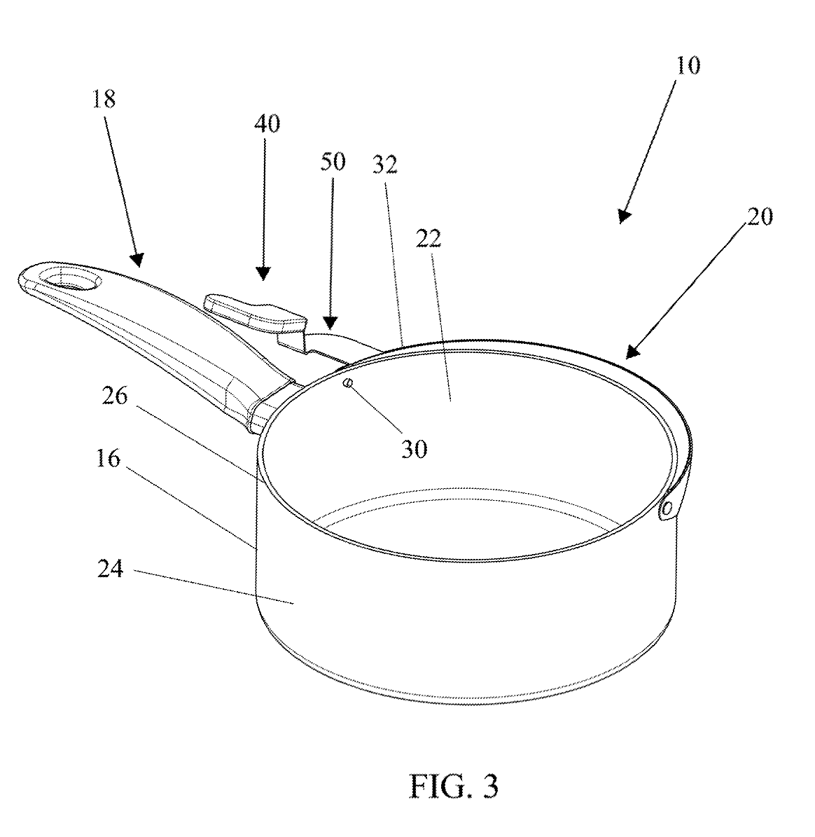

In particular and with reference to FIG. 3, the peripheral wall 16 comprises an interior surface 22 and an exterior surface 24. Generally speaking, in the version 10, the peripheral wall 16 has a substantially vertical cross section or perpendicular to the base 12 (see FIG. 10), showing the peripheral wall 16 extending upward from the base 12 terminating with an upper curved rim 26. Alternatively, it will be known that the peripheral wall 16 upstanding from the base 12 may have a linear cross section or a curved cross section or a combination thereof terminating at the upper curved rim 26. For example, the peripheral wall 16 may extend from the base initially having a curved cross section and then further extend upward (perpendicular to the base 12) with a vertical cross section terminating at the upper curved rim 26 (not shown).

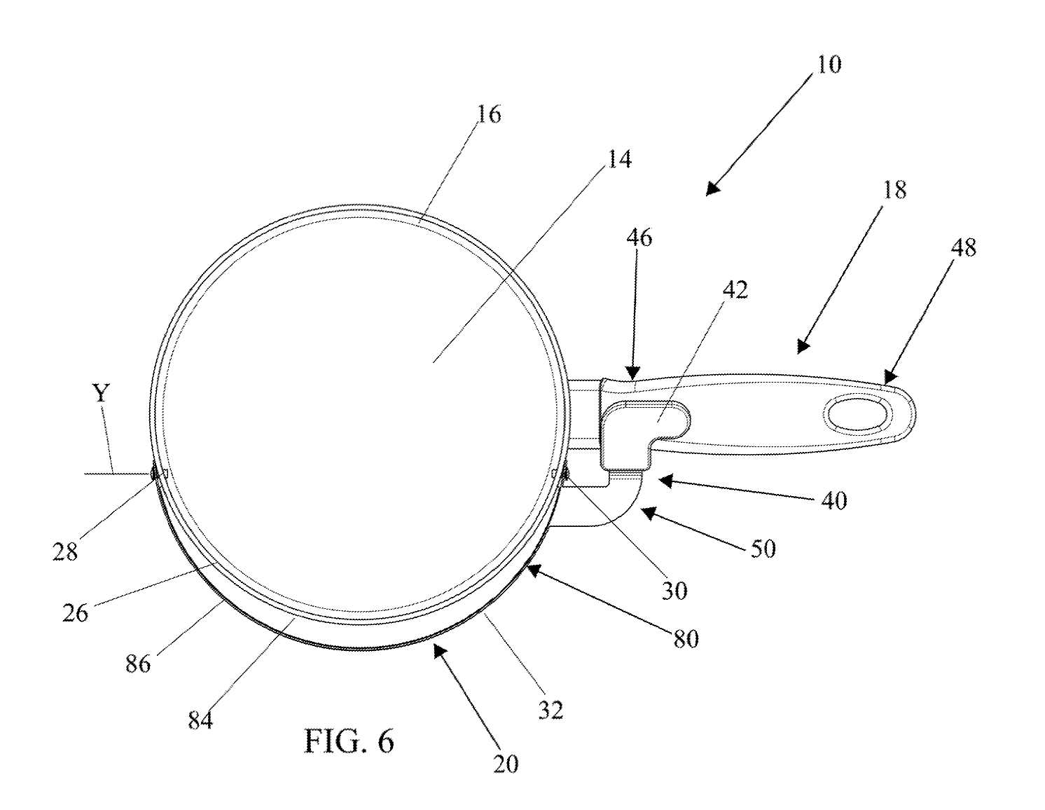

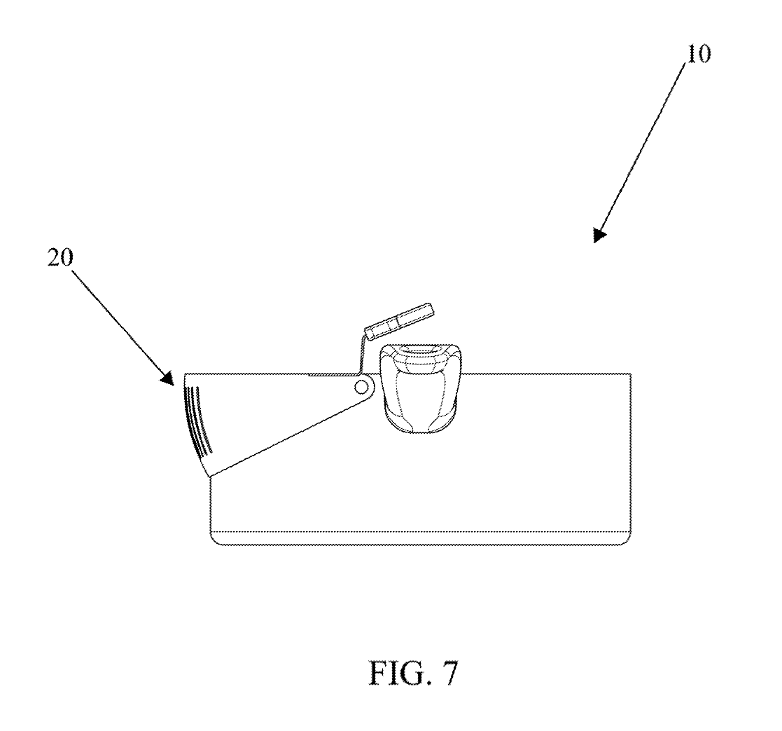

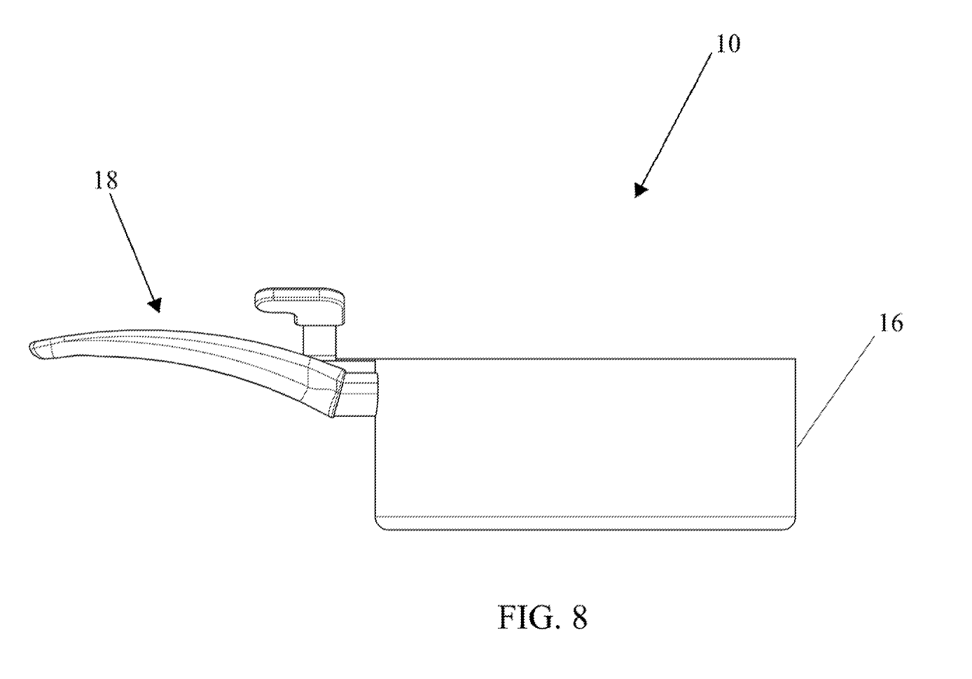

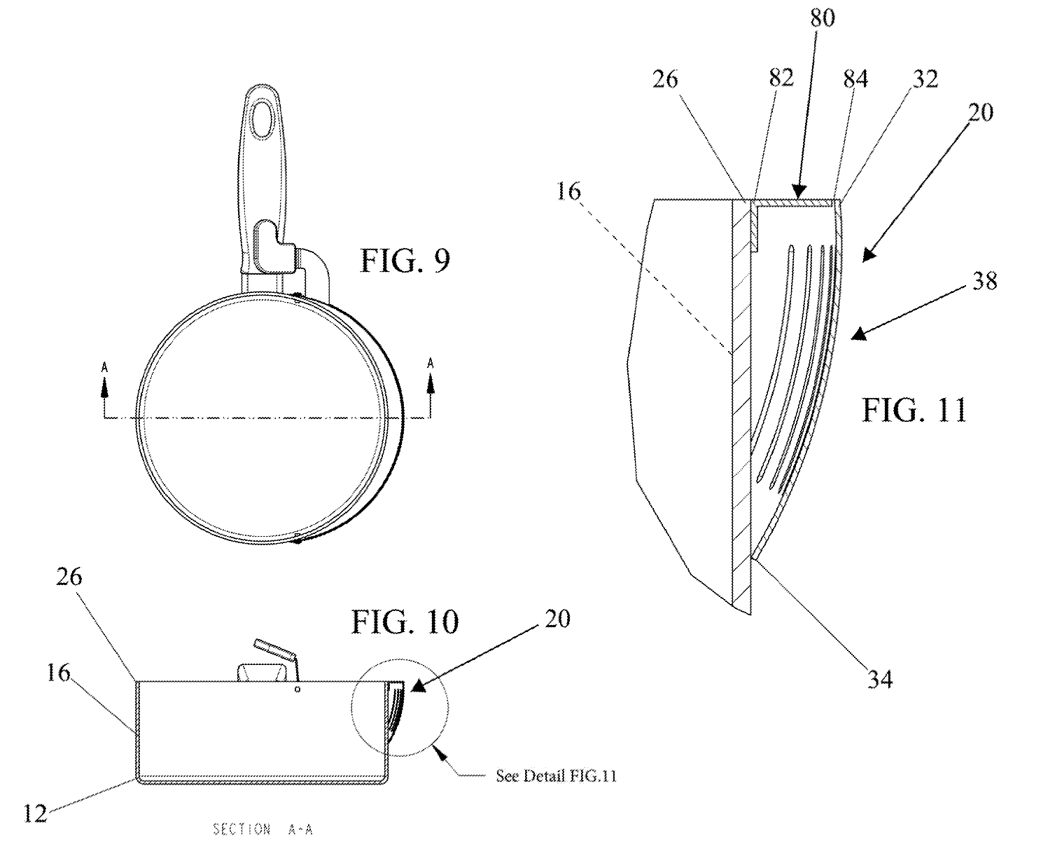

The curved rim extension surface 80 generally extends laterally away from a limited segment of the upper curved rim 26 (See FIG. 2 and FIG. 6) in order to provide a continuous surface providing a seal between the peripheral wall 16 and the pivoting strainer 20. The curved rim extension surface 80 has an inner curved rim perimeter 82 and an outer curved rim perimeter 84 (Also See FIG. 11). The inner curved rim perimeter 82 is concentric to the upper curved rim 26 of the peripheral wall 16 and the outer curved rim perimeter 84 is concentric to the curvature of the pivoting strainer 20.

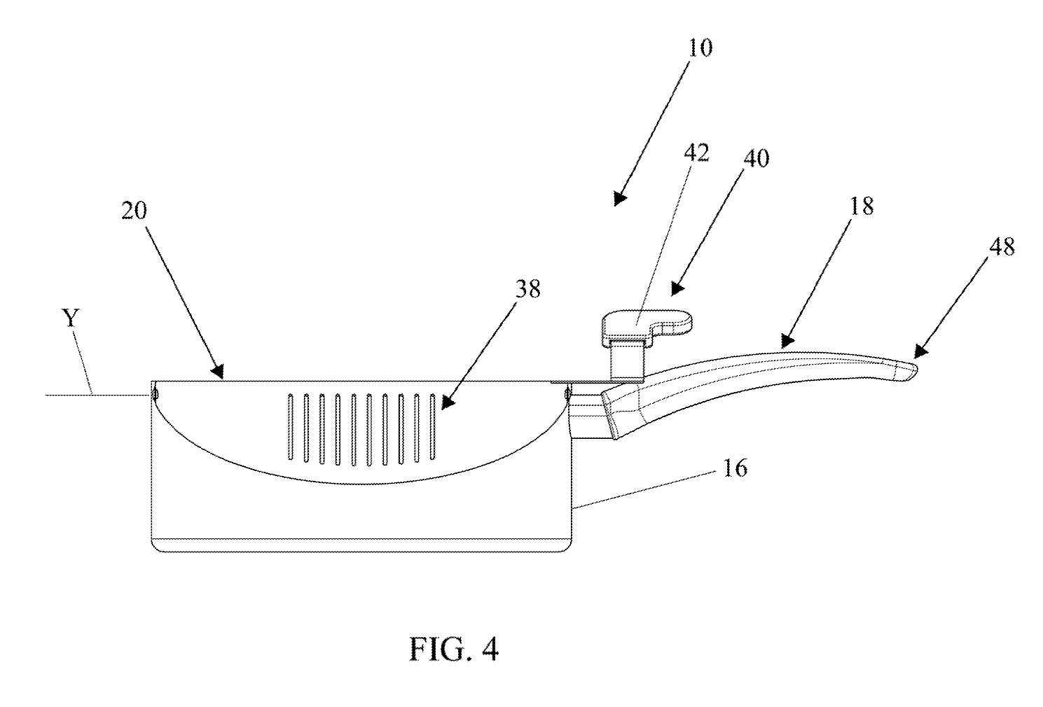

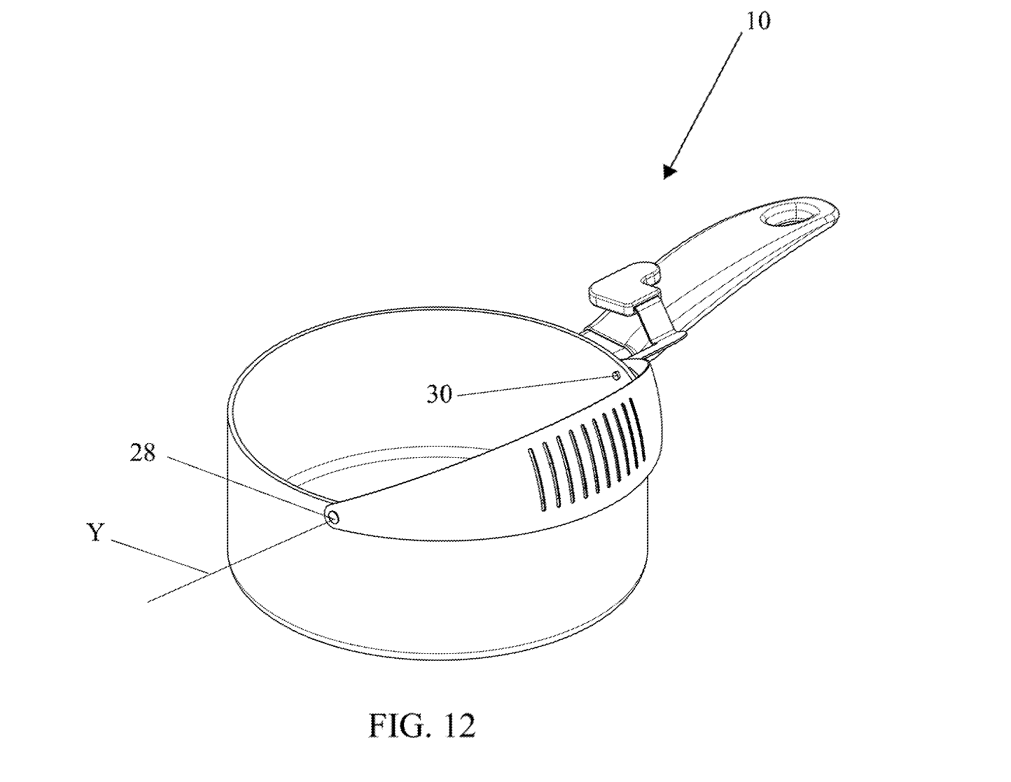

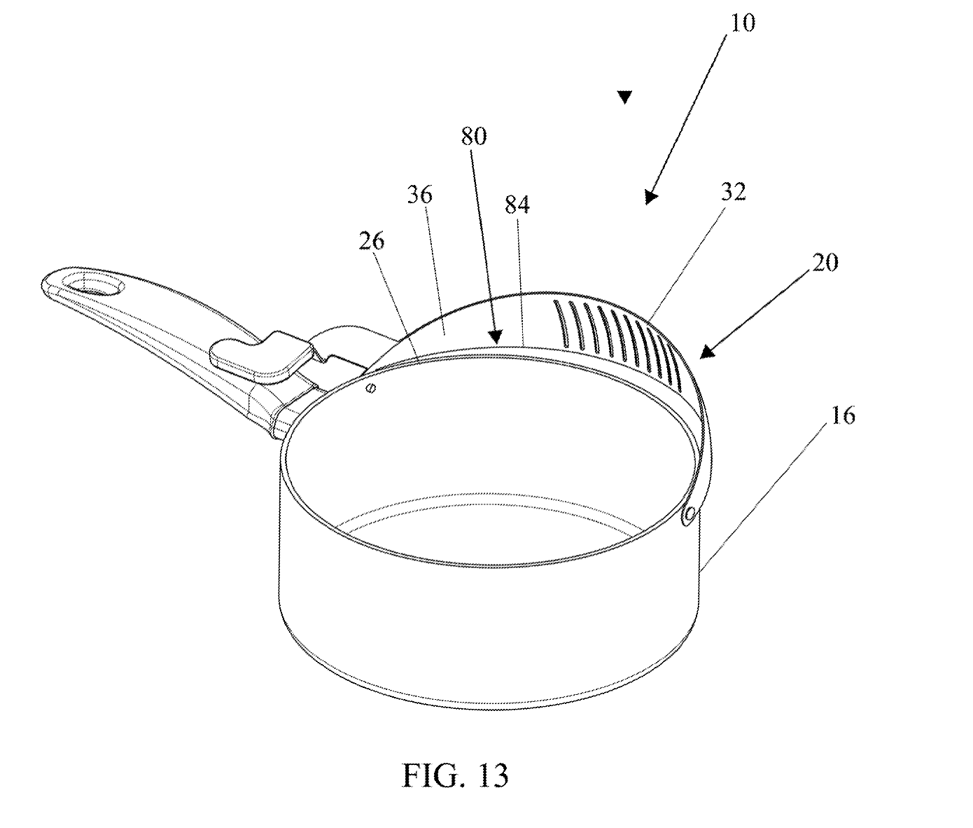

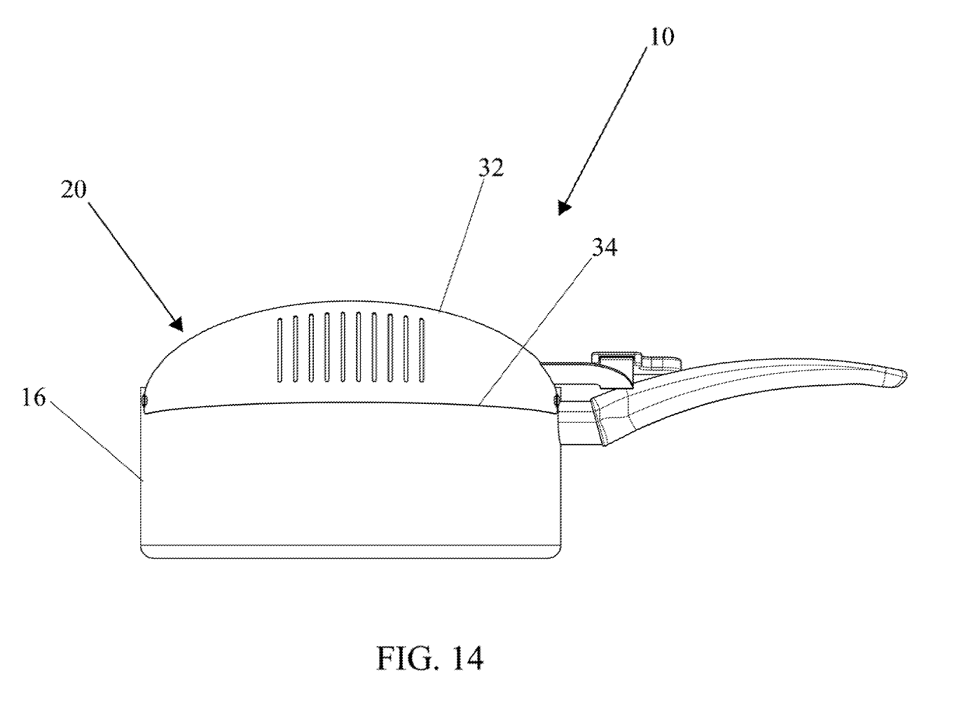

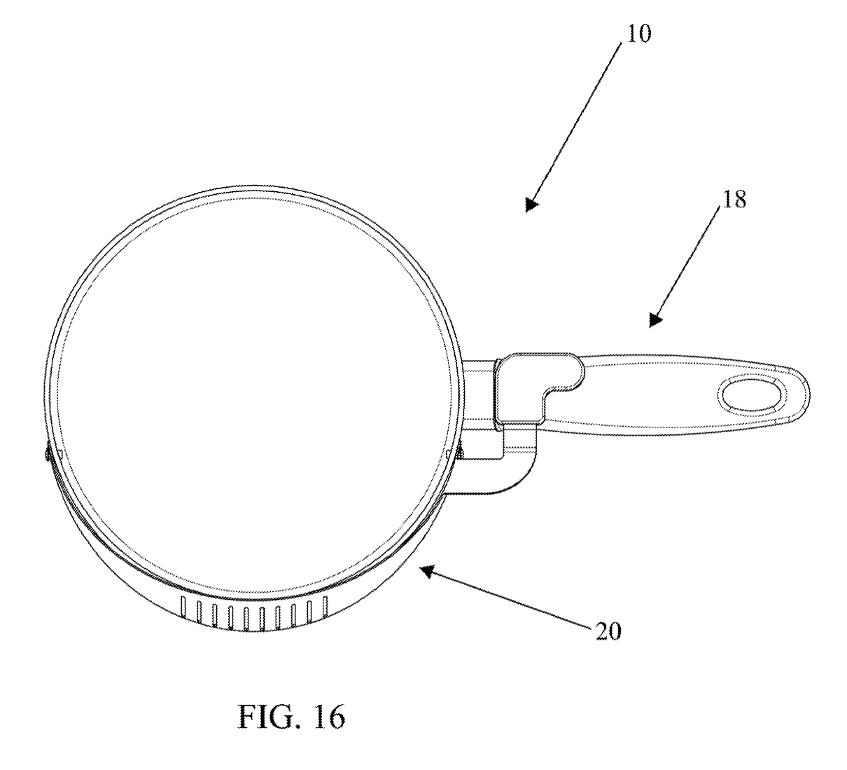

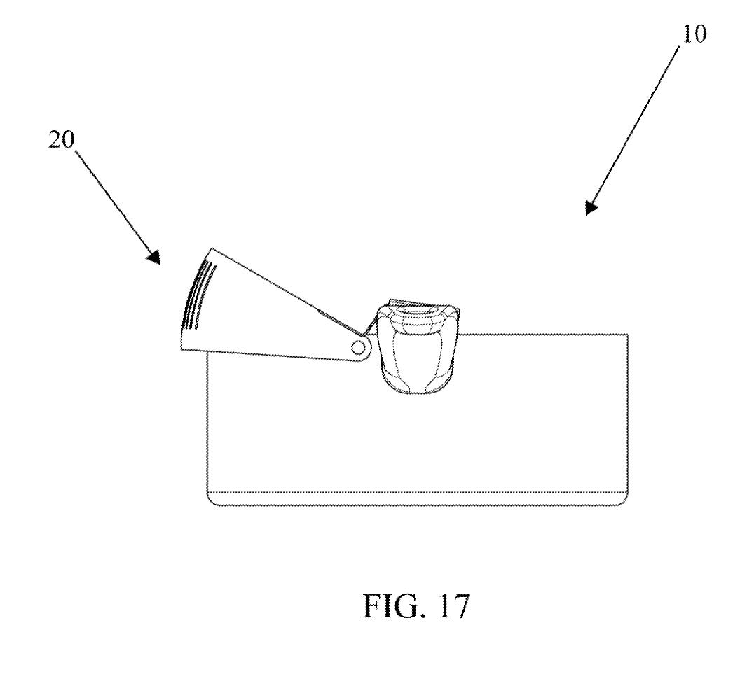

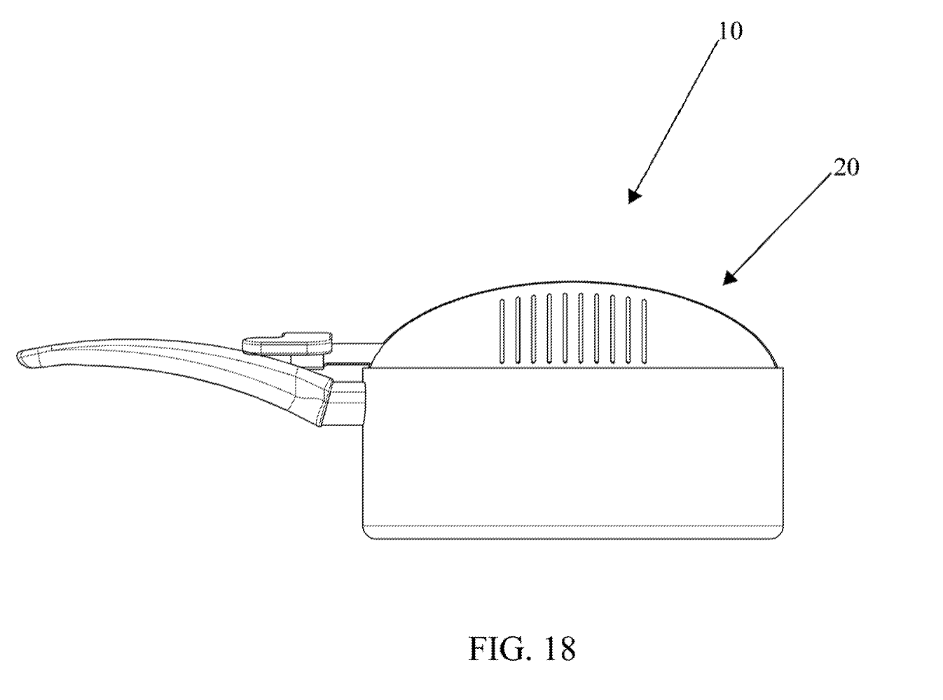

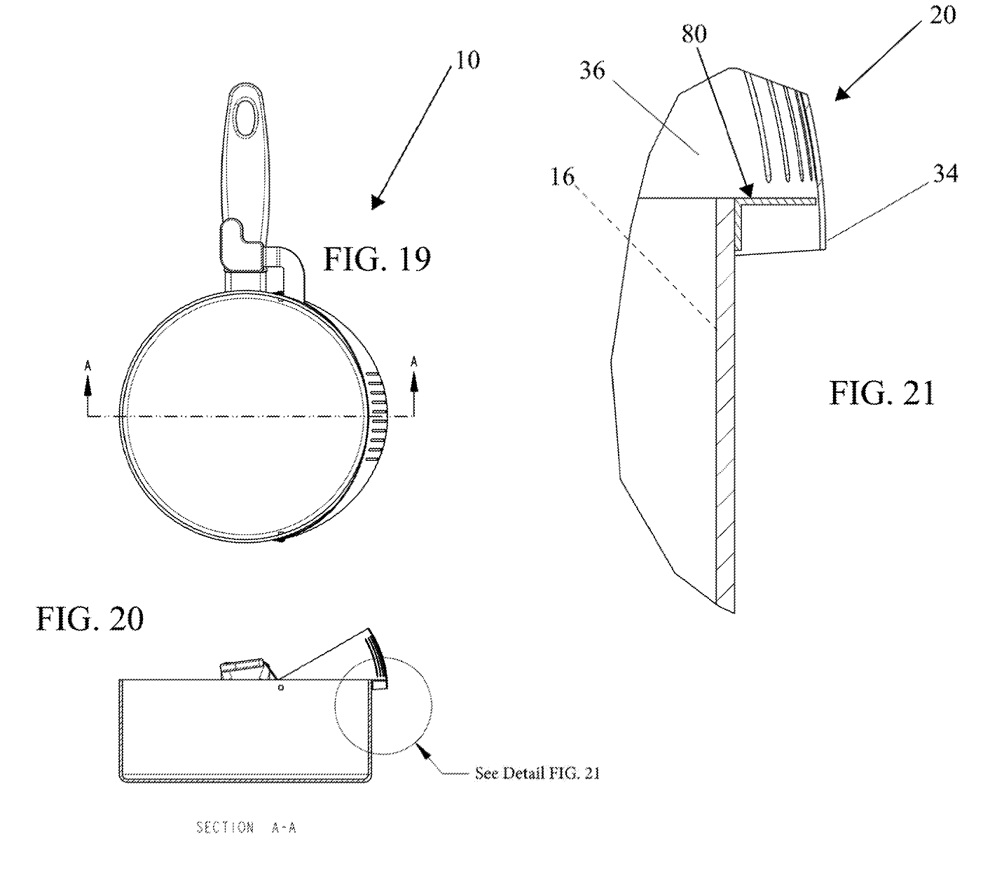

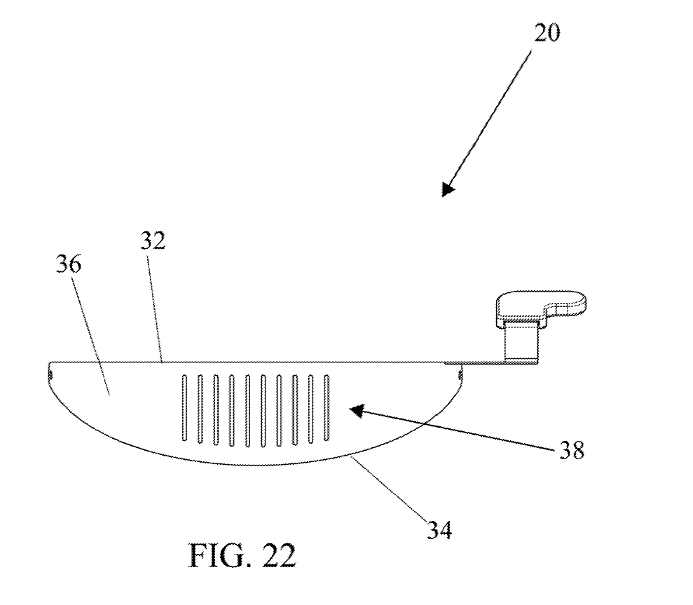

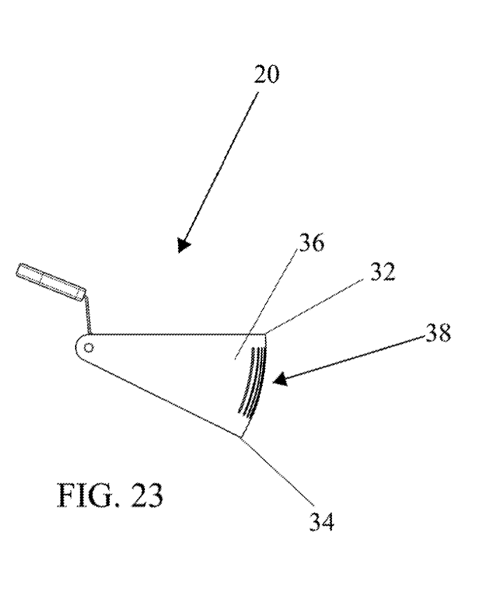

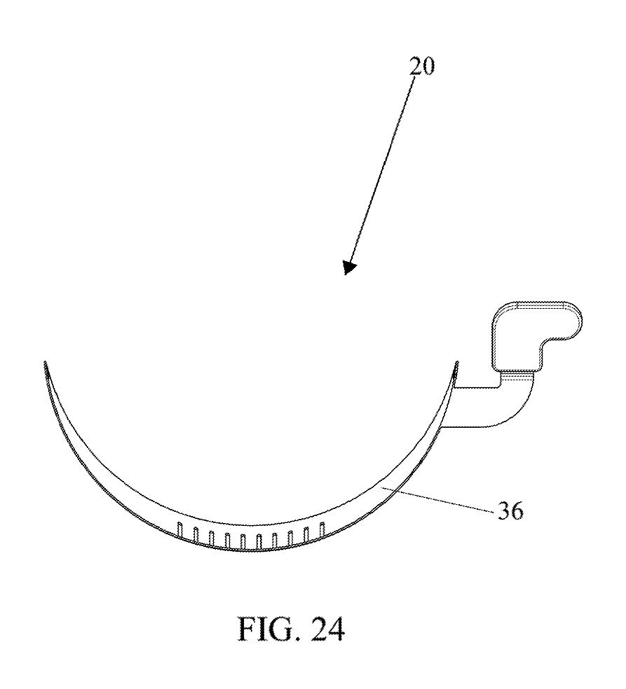

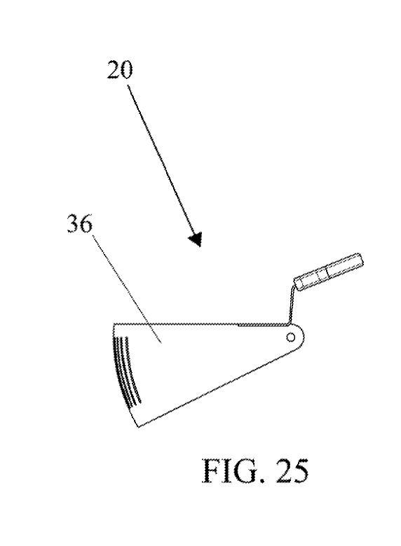

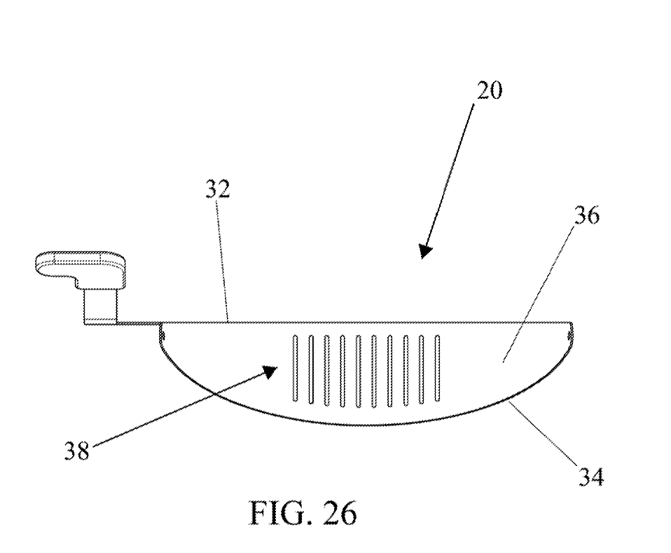

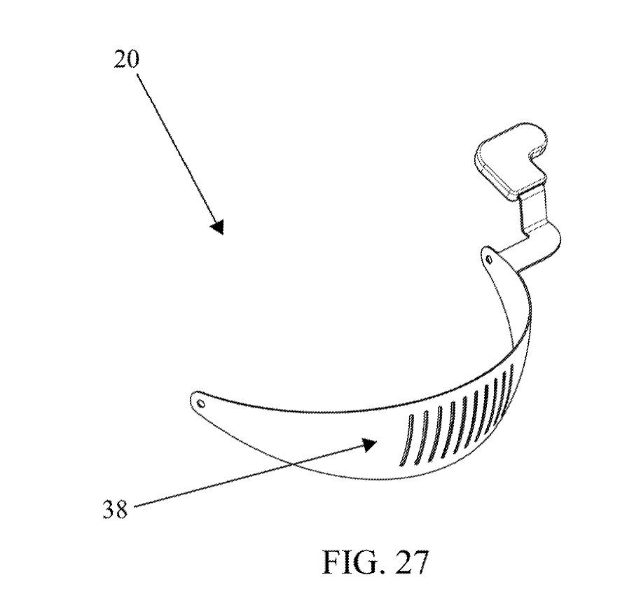

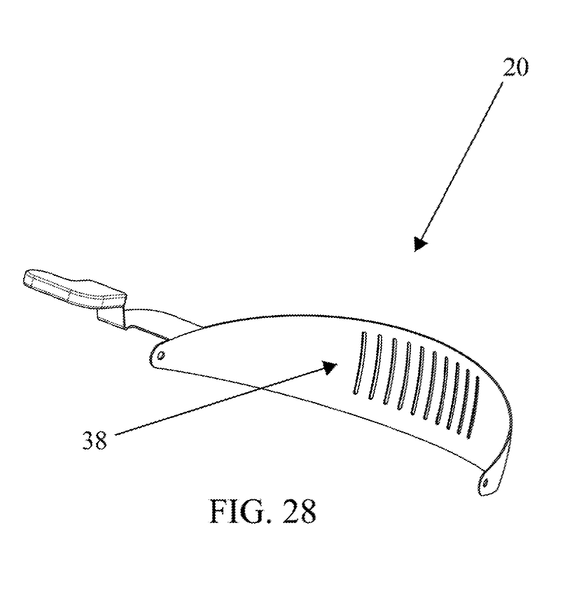

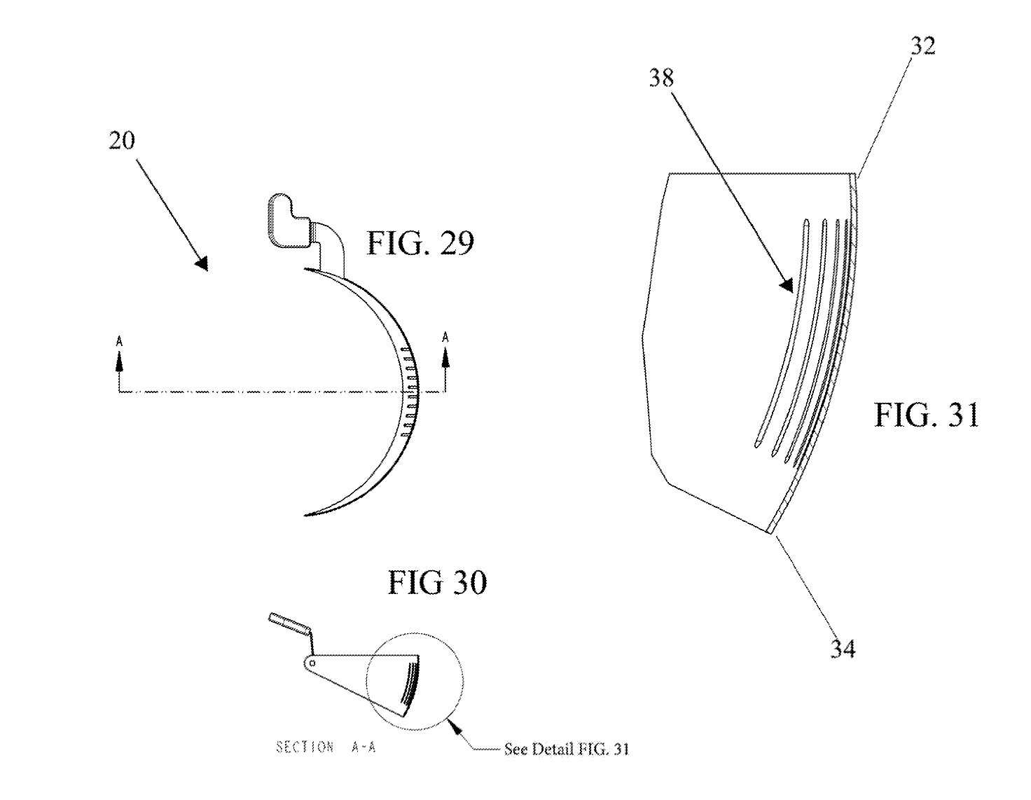

As best illustrated by FIG. 2 and FIG. 22-FIG. 31, the pivoting strainer 20 generally comprises a curved structure or surface 36 which as previously stated is generally concentric with that of the outer curved rim perimeter 84 of the curved rim extension surface 80 (See FIG. 13). However, other countered shapes can be contemplated as alternative versions in order to operably associate the pivoting strainer 20 with the peripheral wall 16 and the upper curved rim 26. The pivoting strainer 20 further comprises an upper perimeter 32, a lower terminating perimeter 34, and a plurality of drainage perforations 38 embedded within the curved surface 36. The pivoting strainer 20 is pivotally attached to the peripheral wall 16 at opposed first and second hinge contact points 28 and 30 forming an axis of rotation Y (See FIG. 12). In particular, the first and second hinged contact points 28 and 30 allow the pivoting strainer 20 to move between a closed position (see FIG. 1) and a raised, draining position (see FIG. 13) about pivot axis Y. As best illustrated by FIG. 12-FIG. 21, while in the draining position, the pivoting strainer 20 extends above a limited segment of the peripheral wall 16, upper curved rim 26, and curved rim extension surface 80 exposing the perforations to the interior contents of the cooking apparatus 10, thereby enabling the passage of liquid from the interior of the cooking apparatus 10 to the exterior thereof. While in the closed position, the pivoting strainer 20 is generally positioned such that it does not interfere with the conventional configuration of the cooking pot and cooking surfaces (see FIG. 1, FIG. 4 and FIG. 11). The hinged contact points 28, 30 can be constructed with permanent rivets or removable fasteners as known in the art.

In a preferred configuration and as best shown in FIG. 1, FIG. 6, FIG. 10 and FIG. 11, the upper perimeter 32 of the pivoting strainer 20 is generally concentric in shape to the curved rim extension surface 80 outer curved rim perimeter 84, wherein while in the lowered, closed position the upper perimeter couples with the curved rim extension surface 80 by an interference type fit providing a seal between the peripheral wall 16 and the pivoting strainer 20.

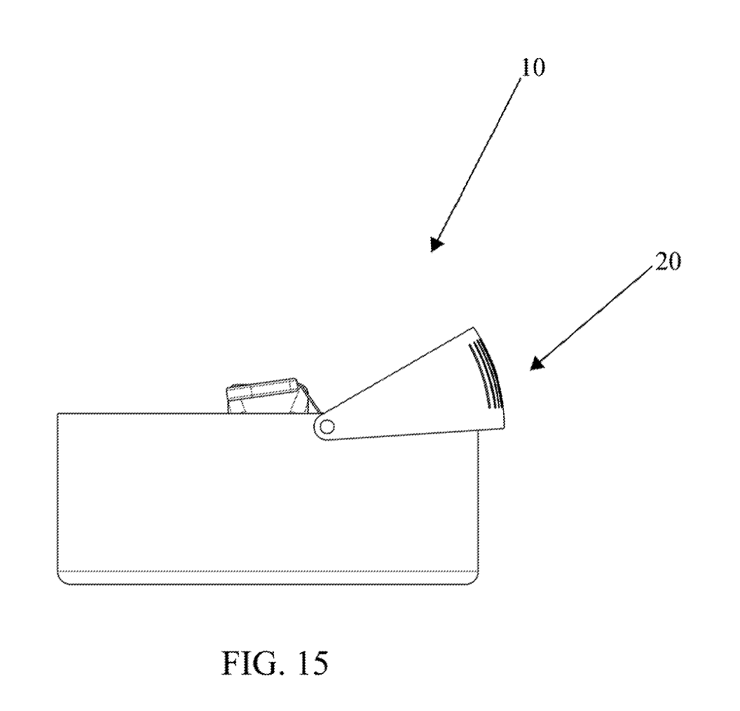

Similarly, in the preferred version and as shown best in FIG. 13, FIG. 15, FIG. 20, and FIG. 21, the lower terminating perimeter 34 of the pivoting strainer 20 is generally concentric in shape to the curved rim extension surface 80 outer curved rim perimeter 84. Thus, while in the raised, draining position the lower terminating perimeter 34 couples with the curved rim extension surface 80 by an interference type fit or by friction, thereby preventing the pivoting strainer 20 from moving upward and providing a seal between the pot 10 and the pivoting strainer 20 during the straining process.

The plurality of drainage perforations 38 are embedded within the curved surface 36 of the pivoting strainer 20 in order to allow the passage of liquid from the interior of the cooking apparatus 10 to the exterior thereof while the pivoting strainer 20 is in the raised, draining position. The drainage perforations 38 are configured and dimensioned to substantially block the passage of solid food therethrough. In the version, the drainage perforations 38 are a plurality of aligned elongated slits extending upward and vertically within the curvature of the curved surface 36.

The pot handle 18 is a supportive member that is sufficiently constructed in order to manipulate and pick up the pot as customarily known in the art. In the version and as best illustrated by FIG. 2 and FIG. 4, the pot handle 18 extends and curves upwardly and laterally outwardly from the peripheral wall 16 generally parallel to the rotating axis Y of the pivoting strainer 20 and perpendicular to the outwardly facing plurality of drainage perforations 38 of the pivoting strainer 20. The position of the handle 18 generally places the drainage perforations facing radially outward from the rotational axis of the user's wrist.

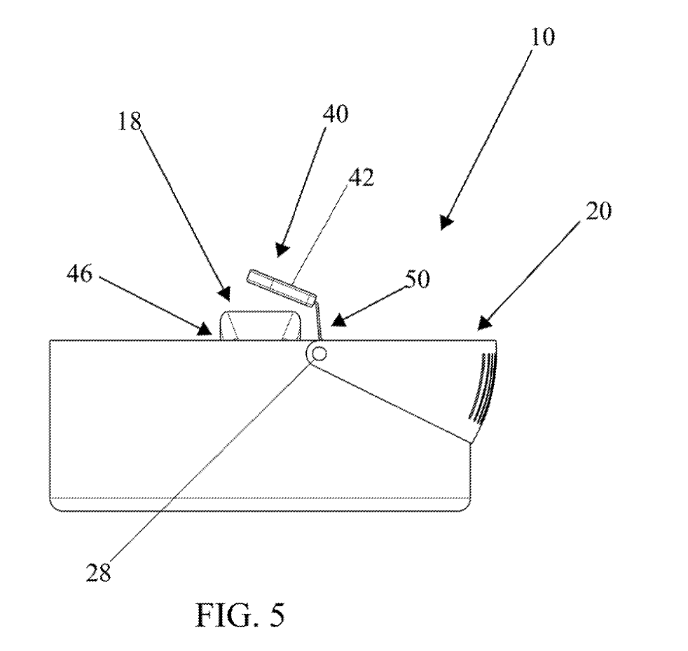

As best introduced by FIG. 1-FIG. 6, the version 10 further comprises a thumb actuated opening lever 40 or a means for moving the pivoting strainer 20 relative to the upper curved rim 26 from the closed position to the raised, draining position. In particular, the opening lever 40 provides the user with the ability to push down with their thumb while simultaneously holding the pot handle 18 in order to move the pivoting strainer 20 into the raised, draining position during operation (See FIG. 13). In the version, the opening lever 40 is attached near the upper perimeter 32 of the pivoting strainer 20 near and preceding the hinged contact point 30 and the Y pivot axis of rotation. Referring in detail to FIG. 6, the opening lever 40 extends outside of the cooking apparatus 10 and is adjacent the peripheral wall 16—extending over the Y pivot axis and above the pot handle 18 near the position of the user's thumb. Thereby, as the opening lever 40 is depressed by the user's thumb while holding the handle 18, the pivoting strainer 20 pivots about the pivot axis Y moving from the closed position to the raised, drainage position.

The opening lever 40 includes a generally flat engagement surface 42 which is suspended overtop of the base 46 of the pot handle 18. Thus, the configuration and position of the opening lever 40 provides the user with the ability to apply a downward force and movement via thumb to the opening lever 40 via the engagement surface 42 generating a rotational action about pivot axis Y moving the pivoting strainer 20 upward and into the raised, draining position during operation.

As illustrated in the version, the lever 40 is configured to generally extend further towards the end 48 of the pot handle 18 from the pivoting strainer 20 via support member 50. This positions the engagement surface 42 in close proximity to the user's thumb while the pivoting strainer 20 is not engaged. Moreover, providing the engagement surface 42 at a similar altitude of where the user's thumb would be positioned on the upwardly and outwardly extending pot handle 18.

The cooking apparatus 10 can be made in any manner and of any material chosen with sound engineering judgment. Preferably, materials will be strong, lightweight, long lasting, economic, and ergonomic. Construction of the cooking apparatus 10 can be made of any known material known in the culinary art or other art such as plastics, cast iron, aluminum, or stainless steel or a combination thereof.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

What is claimed is:

1. A cooking apparatus for straining fluid components away from solid food, comprising:
(a) a substantially flat and circular base having a cooking surface;
(b) a peripheral wall upstanding from the base terminating with an upper curved rim;
(c) a handle extending outwardly from the peripheral wall;
(d) a curved rim extension surface extending laterally away from a limited segment of the upper curved rim and terminating at an outer perimeter;
(e) a pivoting strainer moveable relative to the peripheral wall and curved rim extension surface, the pivoting strainer comprising a curved surface generally concentric to that of the curved extension surface outer perimeter and a plurality of drainage perforations; and
(f) a means for moving the pivoting strainer relative to the upper curved rim between i) a draining position, wherein the pivoting strainer extends above a limited segment of the peripheral wall and curved rim extension surface exposing the drainage perforations to the interior contents of the cooking apparatus; and ii) a closed position wherein the pivoting strainer is positioned such that it does not interfere with the conventional configuration of the cooking apparatus and cooking surfaces.

2. The apparatus of claim 1, wherein the pivoting strainer further comprises a lower terminating perimeter which is concentric to the curved rim extension surface of the cooking apparatus, wherein while in the draining position the lower terminating perimeter couples with the curved rim extension surface by an interference type fit, thereby preventing the pivoting strainer from moving upward and providing a seal between the apparatus and the pivoting strainer during the straining process.

3. The apparatus of claim 1, wherein the pivoting strainer further comprises an upper perimeter which is concentric to the curved rim extension surface outer perimeter, wherein while in the closed position the upper perimeter couples with the curved rim extension surface by an interference type fit.

4. The apparatus of claim 1, wherein the means for moving the pivoting strainer comprises a lever which can be actuated by the user's thumb while holding the apparatus by the handle, the lever is operably attached to the pivoting strainer which is rotatable about a pivot axis and extends above the apparatus handle near the position of the user's thumb, thereby as the lever is depressed by the user's thumb while holding the handle, the pivoting strainer pivots about the pivot axis moving from the closed position to the draining position.

5. The apparatus of claim 1, wherein the drainage perforations are configured and dimensioned to substantially block the passage of solid food therethrough.

6. The apparatus of claim 5, wherein the drainage perforations are a plurality of aligned elongated slits extending upward within the curvature of the pivoting strainer.

7. A cooking apparatus for straining liquid components away from solid food actuated by use of a user's hand and thumb, comprising:
(a) a base having a cooking surface;
(b) a peripheral wall upstanding from the base terminating with an upper curved rim;
(c) a handle extending outwardly from the peripheral wall;
(d) a curved rim extension surface extending away from a limited segment of the upper curved rim terminating at an outer perimeter;
(e) a pivoting strainer defining perforations moveable about a pivot axis relative the peripheral wall and upper curved rim between i) a draining position, wherein the pivoting strainer extends above a limited segment of the peripheral wall and curved rim extension surface exposing the drainage perforations to the interior contents of the cooking apparatus, thereby enabling the passage of liquid from the interior of the apparatus to the exterior of the apparatus, and ii) a closed position, wherein the pivoting strainer is positioned such that it does not interfere with the conventional configuration of the cooking apparatus and cooking surfaces; and
(e) a lever operably attached to the pivoting strainer which is rotatable about a pivot axis and extends above the handle near the position of the user's thumb, wherein the pivoting strainer pivots about the pivot axis moving the pivoting strainer between the closed position and the draining position.

8. The apparatus of claim 7, wherein the pivoting strainer further comprises a lower terminating perimeter which is concentric to the curved rim extension surface outer perimeter, wherein while in the draining position the lower terminating perimeter couples with the curved rim extension surface by an interference type fit, thereby preventing the pivoting strainer from moving upward and providing a seal between the apparatus and the pivoting strainer during the straining process.

9. The apparatus of claim 8, wherein the pivoting strainer further comprises an upper perimeter which is concentric to the curved rim extension surface outer perimeter, wherein while in the closed position the upper perimeter couples with the curved rim extension surface by an interference type fit.

10. The apparatus of claim 7, wherein the pivoting strainer further comprises an upper perimeter which is concentric to the curved rim extension surface outer perimeter, wherein while in the closed position the upper perimeter couples with the curved rim extension surface by an interference type fit.

11. A cooking apparatus for straining grease and other liquid components away from solid food actuated by the use of a user's hand and thumb, comprising:
(a) a substantially flat and circular base having a cooking surface;
(b) a substantially vertical peripheral wall upstanding from the base terminating with an upper curved rim;
(c) a handle extending outwardly from the peripheral wall;
(d) a curved rim extension surface extending away from a limited segment of the upper curved rim terminating at an outer perimeter;
(e) a pivoting strainer defining perforations moveable about a pivot axis relative the peripheral wall and upper curved rim between i) a draining position wherein the pivoting strainer extends above a limited segment of the peripheral wall and curved rim extension surface exposing the perforations to the interior contents of the apparatus, thereby increasing the height of the limited segment of the peripheral wall enabling the passage of liquid from the interior of the cooking apparatus to the exterior of the cooking apparatus, and ii) a closed position wherein the pivoting strainer is positioned such that it does not interfere with the conventional configuration of the cooking apparatus and cooking surfaces; the pivoting strainer comprising a lower terminating perimeter which is concentric to the outer perimeter of the curved rim extension surface, wherein while in draining position the lower terminating perimeter couples with the curved rim extension surface by an interference type fit, thereby preventing the pivoting strainer from moving upward and providing a seal between the apparatus and the pivoting strainer during the straining process; and
(e) a lever operably attached to the pivoting strainer which is rotatable about a pivot axis and extends above the handle proximate the user's thumb, wherein the pivoting strainer pivots about the pivot axis moving the pivoting strainer between the closed position and the draining position.

12. The apparatus of claim 11, wherein the pivoting strainer further comprises an upper perimeter which is concentric to the curved rim extension surface outer perimeter, wherein while in the closed position the upper perimeter couples with the curved rim extension surface by an interference type fit.
